(19) United States
(12) Patent Application Publication
(10) Pub. No.: US 2021/0178408 A1
(43) Pub. Date: Jun. 17, 2021

(54) SHOWERHEAD ASSEMBLY WITH DUAL NOZZLE MOUNT

(71) Applicant: ETL, LLC, RENO, NV (US)

(72) Inventor: DAVID HOFMAN, RENO, NV (US)

(73) Assignee: ETL, LLC, RENO, NV (US)

(21) Appl. No.: 15/931,347

(22) Filed: May 13, 2020

Related U.S. Application Data
(60) Provisional application No. 62/948,563, filed on Dec. 16, 2019.

(51) Int. Cl. B05B 1/18; B05B 1/16; E03C 1/06

(52) U.S. Cl. CPC B05B 1/185; E03C 1/06; B05B 1/1663

(57) ABSTRACT

An improved showerhead assembly is provided for use with handheld showerheads. The handheld showerhead includes an elongate handle and a showerhead face including one or more nozzles for spraying water. In addition, the showerhead assembly includes a hollow mount for affixing to the male threaded pipe found in a shower stall. The mount includes a “C” shaped receptacle for holding the handheld shower assembly, an inlet for receiving water, as well as an outlet for expelling water to a flexible hose, which in turn is connected to the handheld showerhead. In addition, the mount includes supplemental nozzles which can be swiveled to spray water in different directions.

### RELATED APPLICATIONS

The present application claims benefit of U.S. Provisional Patent Application Ser. No. 62/948,563 filed on Dec. 16, 2019.

### BACKGROUND OF THE INVENTION

The present invention relates to showerheads. More particularly, the present invention relates to handheld showerheads producing a plurality of spray patterns.

Showerheads are commercially available in numerous designs and configurations for use in showers, faucets, spas, sprinklers and other personal and industrial systems. The vast majority of showerheads include spray heads which may be categorized as being either stationary or oscillating and have either fixed or adjustable openings. Stationary spray heads with fixed jets are the simplest constructions consisting essentially of a central conduit connected to one or more spray nozzles directed to produce a constant pattern. The stationary spray showerheads cause water to flow through the construction to contact essentially the same points on a user's body in a repetitive fashion.

Multifunction showerheads are able to deliver water in many different spray patterns such as a fine spray, a coarse spray, a pulsating spray, or even a flood pattern providing high fluid flow but decreased velocity. Of course, many other spray patterns may also be provided.

A conventional multifunction showerhead generally requires the user to turn a selector ring or dial on the showerhead faceplate in order to select a desired function. Another approach is to provide a faceplate with several spray jets located in concentric circular patterns. An internal controller, such as controlled by buttons or the like, may be operated to direct the incoming water to any of the various patterns. Examples of such constructions are disclosed in U.S. Pat. Nos. 5,433,384 and 6,622,945.

A handheld showerhead assembly typically includes a hollow handle connected to a water supply by a flexible rubber hose. The handle has a proximal end which typically has a threaded inlet for connecting to a rubber hose. Meanwhile, at the handle's distal end, the showerhead assembly includes a showerhead including a plurality of nozzles for ejecting water. Typically, the handle and showerhead face are angled relative to one another so that water is ejected at approximately 90° relative to the handle's longitudinal axis.

Advantageously, the showerhead handle allows users to manipulate the spray nozzles into various positions and alignment to assist in the cleaning process. Unfortunately, though handheld showerheads provide many advantages compared to their fixed showerhead counterpart, handheld showerheads still suffer from several disadvantages. For example, many handheld shower assemblies do not allow a user to direct water to multiple locations at the same time.

More recently, shower stalls have been provided with a primary showerhead, and additional nozzles which project directly from the shower stall's walls which spray water in different directions than the primary showerhead. Unfortunately, these constructions require that expensive plumbing additions be made to the shower stall facility. Further, the wall nozzles cannot be moved to provide the variety that would be desirable for a shower user.

Thus, it would further be advantageous to provide a showerhead assembly that included a primary showerhead as well as one or more supplemental showerhead nozzles which can direct water to different locations within a shower stall.

Further, it would be advantageous to provide a showerhead assembly that included supplemental nozzles that did not require expensive modifications to the traditional shower stall architecture such as the introduction of additional plumbing within the walls of the shower stall.

### SUMMARY OF THE INVENTION

The present invention addresses the aforementioned disadvantages by providing an improved handheld showerhead assembly which includes a mounting structure for supporting a handheld showerhead. The showerhead assembly includes a traditional handheld showerhead including a primary showerhead having a plurality of nozzles for expelling water such as within a shower. The handheld showerhead further includes a hollow handle with a proximal end which preferably is threaded for connecting to a flexible hose. The handle is elongate so as to define a longitudinal axis, and preferably, the distal end of the handle affixes to the showerhead at an angle, such as 45° to 90°. Additionally, the handheld showerhead includes a channel having an inlet for receiving water for being expelled from the showerhead nozzles. Various channel, conduit and nozzle constructions can be determined by those skilled in the art for diverting water from the inlet to the showerhead's nozzles. In the preferred embodiment, the showerhead includes a controller knob for selecting a desired shower spray pattern.

Moreover, the showerhead assembly of the present invention further possesses a hollow mounting structure with a “C” shaped receptacle for receiving the proximal end of the hollow handle. The mount has an inlet which preferably is threaded for connecting to a water supply such as a male threaded pipe projecting from a shower wall. Preferably, the mount's housing is affixed to the inlet by ball joint so as to allow rotation about a central axis. The housing has a central conduit that delivers water to a primary hose outlet and to supplemental sprayer assemblies.

In the preferred embodiment, the sprayer assembly's mount includes a pair of swiveling nozzle assemblies that are connected to nozzle conduits which, in turn, are connected to the central conduit for receiving water. Each swiveling nozzle assembly includes a proximal end which is shaped like a ball that is pivotally encapsulated within a spherical cavity formed in the mount's housing. This ball joint arrangement enables the direction of these supplemental nozzles to be changed as desired by the bather. Preferably, a valve construction consisting of an on/off button is incorporated onto the mount so as to permit and/or obstruct water flow from the conduits to the nozzles. Even more preferably, water flow is blocked by depression of the valve button, and conversely, water flow is promoted when the button is not depressed. Additional or alternative valve assemblies for providing these capabilities can be selected by those skilled in the art.

Advantageously, the showerhead assembly provides greater flexibility in providing spray patterns in the shower environment.

Also advantageously, the showerhead assembly does not require expensive modifications to the traditional shower stall architecture.

Other features and advantages of the present invention will be appreciated by those skilled in the art upon reading the detailed description which follows with reference to the drawings.

### BRIEF DESCRIPTION OF THE DRAWINGS

FIG. 1 is a front perspective view of a showerhead mount with swiveling nozzles;

FIG. 2 is a front perspective view of the showerhead mount with swivel nozzles wherein the mount's inlet has been pivoted downwardly;

FIG. 3 is a front perspective view of the showerhead mount with swiveling nozzles illustrating that the mount's inlet and mount's nozzles can be pivoted upwardly, downwardly, left or right;

FIG. 4 is a front perspective view of the showerhead mount with swiveling nozzles illustrating that both of the mount's nozzle assemblies having been pivoted left and right;

FIG. 5 is a perspective view of the showerhead assembly;

FIG. 6 is a top plan cutaway view of the mount illustrated in FIG. 1;

FIG. 7 is a top plan cutaway view of the mount illustrated in FIG. 1 wherein the valve button has been depressed so as to prevent the flow of water to the mount nozzles;

FIG. 8 is a left side cutaway view of the mount illustrated in FIG. 6 wherein the mount's supplement nozzles are expelling water; and

FIG. 9 is a side cutaway view of the mount illustrated in FIG. 7 illustrating the flow of water to a flexible hose, but not to the mount nozzles.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

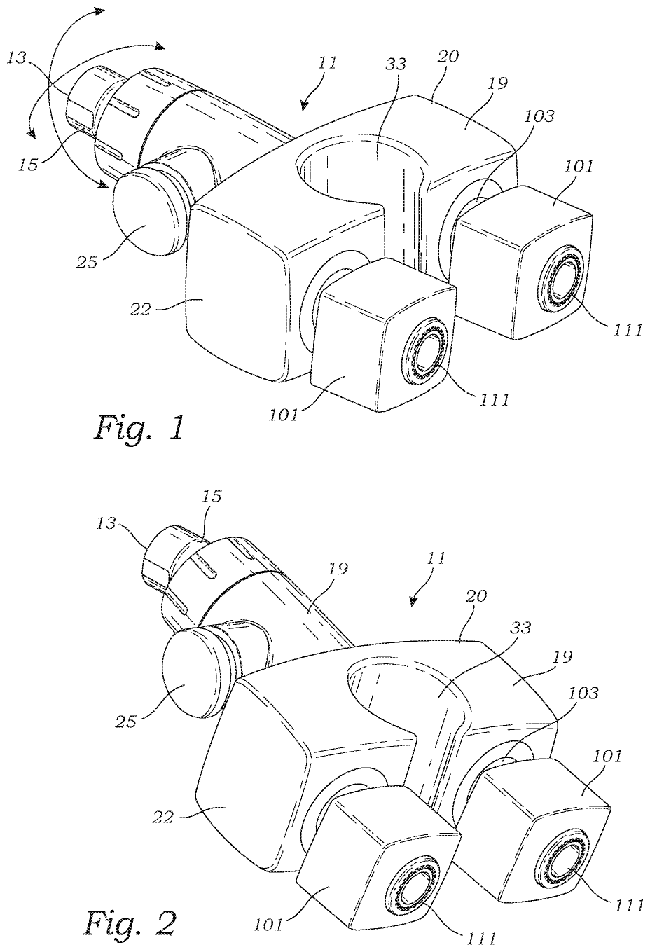

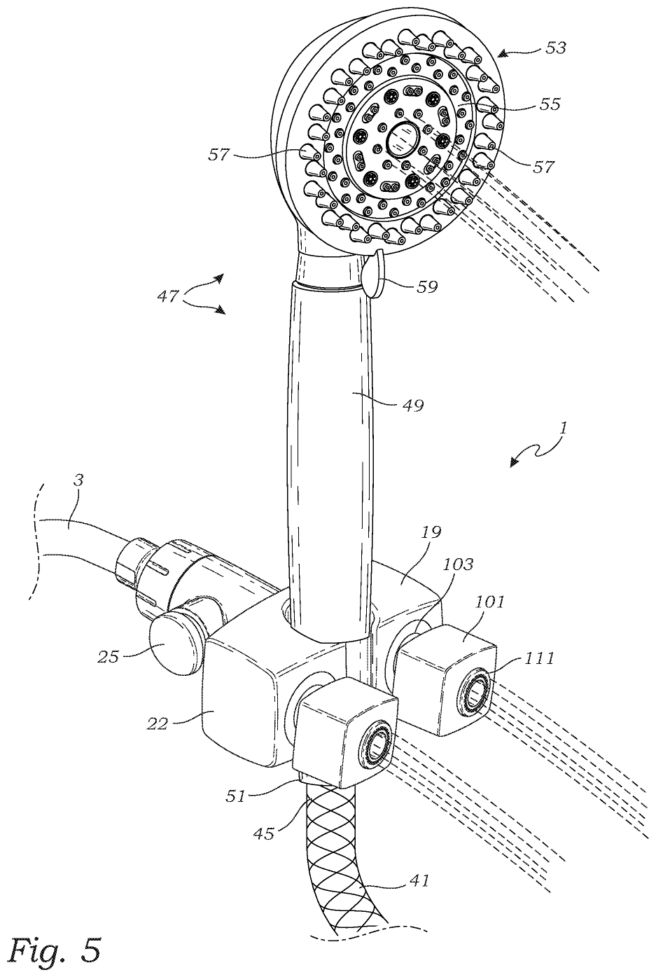

With reference to all FIGS. 1-9, the showerhead assembly 1 includes a mounting structure 11 for supporting a handheld showerhead assembly 47. The handheld showerhead portion of the showerhead assembly 1 has a relatively traditional construction including a hollow handle 49 having a proximal end 51 which affixes to a flexible hose 41, and a distal end which includes a showerhead 53. The handle 49 includes a longitudinal axis, and preferably the showerhead 53 affixes to the distal end of the handle 47 at an angle, such as 45° to 90°, relative to the handle's longitudinal axis. The showerhead assembly's primary showerhead 53 has a face 55 through which a plurality of nozzles 57 project. As understood by those skilled in the art, water is capable of flowing through a central channel (not shown) within the center of the handle 49 which connects to the showerhead's nozzles 57 which are constructed to spray water. Preferably, but not necessarily, the showerhead 53 includes a controller, such as the controller knob 59, which is capable of altering the flow of water so as to provide the showerhead with the capability of producing different spray patterns. As illustrated in FIG. 5, preferably the handheld showerhead's hollow handle 49 has a proximal end which has male threads 51 so as to couple to the female threaded connection 43 found on a traditional flexible hose 41.

The showerhead assembly 1 has a unique hollow mounting structure 11 for holding the showerhead assembly's hollow handle 49. As illustrated in each of the Figures, the mount 11 includes an inlet 13 which connects to a water supply. Preferably, the inlet 13 includes female threads 17 for connecting to the male threads found at the end of a traditional shower stall pipe 3. Preferably, the mount's hollow housing 19 is connected to the mount's inlet 13 by a ball joint 15. As illustrated in the Figures, the ball joint 15 allows the mount 11 to rotate and swivel in any direction about the ball joint's center.

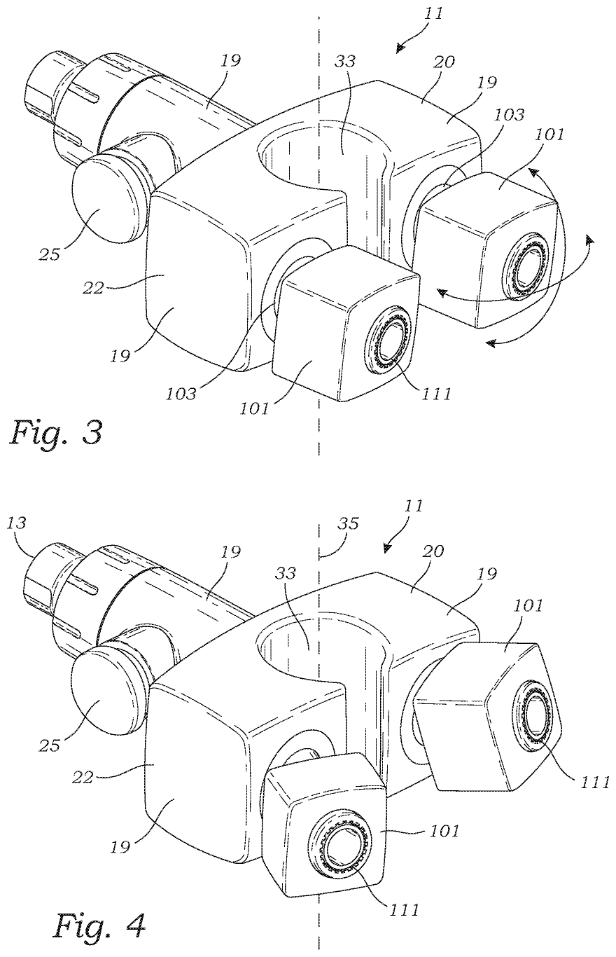

As illustrated in FIGS. 1-9, like traditional handheld showerhead mounting structures, the preferred mount 11 includes a housing 19 which has a central conduit 21 and hose conduit 27 which connects the inlet 13 to a primary hose outlet 29. Preferably, the mount's primary outlet 29 includes male threads for connecting to the female threaded inlet 43 of the flexible hose 41. As illustrated in FIG. 1-9, the mount 11 includes a “C” shaped receptacle 33 for receiving the proximal end 51 of the handheld shower assembly 47. When held by mount 11, the handheld shower assembly's longitudinal axis aligns with the “C” shaped receptable's vertical axis 35, as illustrated in FIGS. 3 and 4. Preferably, the “C” shaped receptacle is located substantially at the midpoint of the housing 19, and separates the housing into two shoulder sections, including a left side shoulder section 20 and a right side shoulder section 22.

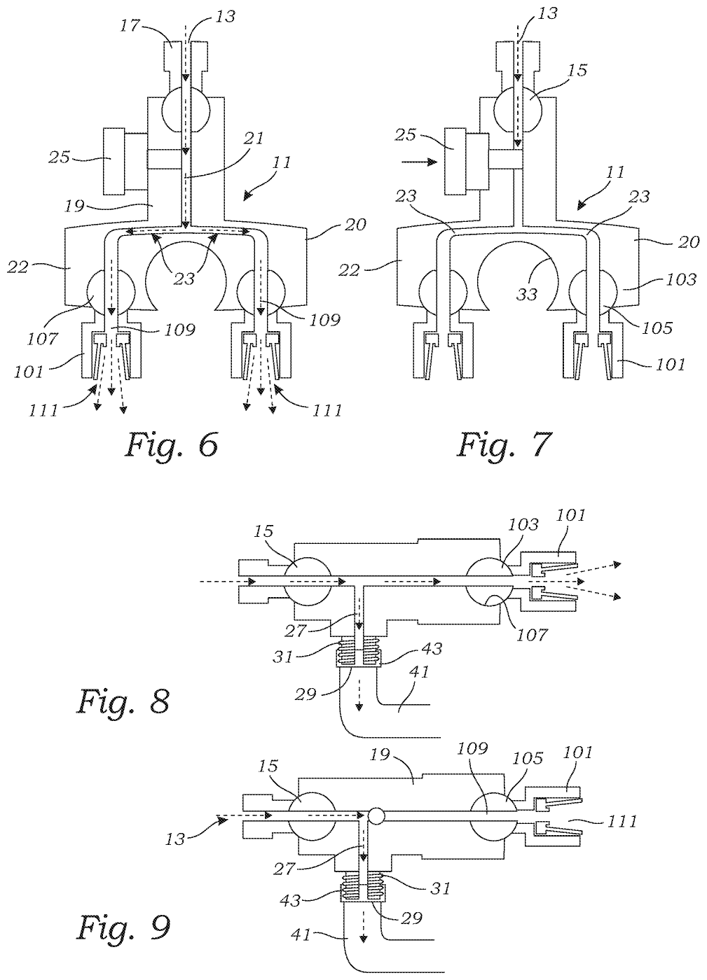

As best illustrated in FIGS. 6 and 7, the mount 11 includes a pair of nozzle conduits 23 which connect to the central conduit 21 to supply water to supplemental sprayer assemblies 101. More specifically, for this embodiment, the nozzle conduits 23 transport water to nozzles 111 located in rotatable nozzle housings 101. To provide pivot rotation, each nozzle housing 101 is connected to the mount's housing 19 by a ball joint 103. Each ball joint 103 includes a ball 105 which forms the proximal end of each nozzle's housing 101, and each nozzle housing's ball 105 is pivotally positioned within a spherical chamber 107 formed in the mount's housing 19. Advantageously, each of the nozzle housings 101 are capable of pivoting both upwardly and downwardly, as well as left and right, so as to be able to spray water throughout a shower stall, as desired by the bather.

As illustrated in FIGS. 6-9, preferably, but not necessarily, the mount 11 includes an on/off valve 25 which permits or obstructs the flow of water from the housing's inlet 13 to the nozzle conduits 23. As illustrated in FIGS. 6 and 7, the preferred valve consists of an on/off button 25 with depression of the button causing the conduit 21 to close to prevent water from flowing to the nozzle conduits 23. For example, FIGS. 6 and 8 illustrate the valve button 25 not depressed to allow water to flow through the central conduit 21 to the sprayer assemblies 101. Conversely, FIGS. 7 and 9 illustrate the valve button depressed to obstruct the flow of water through conduit 21 to the nozzle conduits 23. This valve construction 25 may be incorporated into any mount embodiments including the embodiment illustrated in FIGS. 1-9. Furthermore, the showerhead assembly may incorporate additional or alternative valve assemblies. For example, a preferred valve (not shown) may be capable of activating or deactivating any of the valve assemblies such as a valve which provides three modes including: 1) on—mount nozzles and on—handheld showerhead; 2) on—mount nozzles and off—handheld showerhead; and 3) off—mount nozzles and on—handheld showerhead. The mount may also incorporate a valve assembly (not shown) which can selectively activate or deactivate either of the two mount spray assemblies, such as to activate the left mount nozzles but deactivate the right mount nozzles, or to deactivate the left mount nozzles but activate the right mount nozzles. Various valve constructions for providing these capabilities can be selected by those skilled in the art.

The present shower assembly provides an improved mounting structure for holding a handheld shower assembly. Advantageously, the mount 11 provides a variety of different nozzle configurations which provide supplemental streams of water. Also advantageously, the supplemental streams of water can be diverted to different locations within the shower enclosure.

While preferred showerhead assemblies have been illustrated and described, it will be apparent that various modifications can be made without departing from the spirit and scope of the invention. For example, preferred showerhead mounts may include only a single nozzle assembly, or the mount may possess three or more nozzle assemblies. However, the preferred showerhead assemblies described and illustrated herein include a mount having two adjustable nozzle assemblies. Still alternative embodiments may be envisioned by those skilled in the art after consideration of the present disclosure. Accordingly, it will be apparent that various modifications can be made without departing from the spirit and scope of the invention. Therefore, having described my invention in such terms such as to enable a person skilled in the art to understand the invention, recreate the invention and practice it, and having presently identified the presently preferred embodiments thereof,

I claim:

1. A handheld showerhead assembly comprising:
a handheld showerhead including a primary showerhead and an elongate hollow handle, said primary showerhead having a front face and a plurality of nozzles projecting from said front face, said elongate hollow handle having a proximal end and a distal end with said distal end affixed to said primary showerhead, said handheld showerhead further including a channel connecting said hollow handle's proximal end to said nozzles for transporting water received from said handle's proximal end to said nozzles;
a flexible hose having first and second ends with said first end being connected to said elongate handle's proximal end;
a showerhead mount including a housing, a female threaded inlet, a male threaded outlet which is connected to said flexible hose's second end, and a central conduit connecting said female threaded inlet to said male threaded outlet, said housing further including a “C” shaped receptacle sized and shaped to receive and hold the proximal end of said handheld showerhead, said “C” shaped receptacle separating said showerhead mount's housing into a first side shoulder section and a second side shoulder section;
said showerhead mount further including a first supplemental sprayer assembly, said first supplemental sprayer assembly is mounted to said first side shoulder section by a first ball joint so as to enable said first supplemental sprayer assembly to swivel relative to said housing, said mount further including a first nozzle conduit connecting said central conduit to said first supplemental sprayer assembly for supplying water from said central conduit to said first supplemental sprayer assembly.

2. The handheld showerhead assembly of claim 1 wherein said first ball joint includes a first substantially spherical cavity formed in said housing's first shoulder section and said first supplemental sprayer includes a first ball rotatably positioned in said first spherical cavity.

3. The handheld showerhead assembly of claim 1 wherein said showerhead mount further including a second supplemental sprayer assembly mounted to said second shoulder section by a second ball joint so as to enable said second supplemental sprayer assembly to swivel relative to said housing, said mount further including a second nozzle conduit connecting said central conduit to said second supplemental sprayer assembly for supplying water from said central conduit to said second supplemental sprayer assembly.

4. The handheld showerhead assembly of claim 3 wherein said first ball joint includes a first substantially spherical cavity formed in said housing's first shoulder section and said first supplemental sprayer includes a first ball rotatably positioned in said first spherical cavity, and said second ball joint includes a second substantially spherical cavity formed in said housing's second shoulder section and said second supplemental sprayer includes a second ball rotatably positioned in said second spherical cavity.

5. The handheld showerhead assembly of claim 1 wherein said hollow handle extends longitudinally to define a longitudinal axis, and said, showerhead's front face faces at an angle between 45° and 90° relative to said handle's longitudinal axis.

6. The handheld showerhead assembly of claim 1 wherein said hollow handle extends longitudinally to define a longitudinal axis, and said, showerhead's front face faces at an angle between 45° and 90° relative to said handle's longitudinal axis, and said first and second supplemental sprayer assemblies face in substantially the same direction as said primary showerhead.
